(19) United States
(12) Patent Application Publication
(10) Pub. No.: US 2012/0185262 A1
(43) Pub. Date: Jul. 19, 2012

(54) TRAVEL-RELATED METHODS, SYSTEMS AND DEVICES

(75) Inventors: Michael Anthony Dalesandro, Chicago, IL (US); Craig Ulliott, South Holland, IL (US)

(73) Assignee: WHERE I'VE BEEN LLC, Chicago, IL (US)

(21) Appl. No.: 13/434,387

(22) Filed: Mar. 29, 2012

Related U.S. Application Data
(63) Continuation of application No. 12/173,627, filed on Jul. 15, 2008, now abandoned.

(51) Int. Cl. G06Q 99/00; G06F 15/16; G06F 17/30

(52) U.S. Cl. 705/1.1; 707/754; 707/748; 707/E17.005

(57) ABSTRACT

A method for sharing travel-related information over a network includes enabling a user access travel-related information on a data storage device. The data is generated and transmitted by a system hosted any of several different social networking platforms. The method includes retrieving the travel-related data for multiple users over the network and displaying different maps which visually indicate the data. A method for displaying travel options includes displaying a map, enabling a user to designate travel criteria, enabling the user to change the criteria, and updating a visual representation of the search results concurrently with the user's criteria change. A method for searching reviews includes filtering reviews based on a degree of correspondence between a searcher and the personality profiles of the different reviewers.

### PRIORITY CLAIM

This application is a continuation application of, claims the benefit of and priority to U.S. patent application Ser. No. 12/173,627, filed on Jul. 15, 2008, the entire contents of which is incorporated by reference herein.

### BACKGROUND

People travel to or visit paces for a variety of reasons, such as vacation, business, entertainment, eating, etc. Many of these people like to share their travel or visit-related experiences with their friends and others within their social network. Websites or other online social networking platforms have developed which enable users to store certain information about themselves in an online account or profile. The users of these websites are able to view certain information about one another. It can be time consuming, inconvenient or cumbersome to store, track and share certain types of personal information, such as travel or visit-related experiences.

There is a need to overcome or lessen the effects of such disadvantages. There is also a need to provide improvements to online social environments. Furthermore, there is a need to facilitate the electronic storage, tracking and sharing of travel and visit-related information and experiences.

### SUMMARY

The present disclosure relates to several embodiments of travel-related or visiting-related methods, systems and devices. One embodiment includes a method for sharing travel-related information over a network. The method includes (a) displaying a map having a plurality of selectable geographical regions; and (b) enabling a user to select one of the geographical regions and associate an initial travel status with said geographical region. For each selected geographical region, the method includes enabling the user to change the initial travel status to at least one other travel status. The method also includes: (a) storing the selected geographical regions and associated travel statuses in a data storage device; and (b) enabling the user and at least one other user to access the data over the network. For each of the selected geographical regions, the method includes indicating the associated travel status on the map.

Another embodiment includes a method for storing travel-related information. The method includes: (a) displaying a map of a geographical region, wherein the geographical region includes a plurality of selectable destination areas; (b) enabling a user to select at least one of the destination areas; (c) highlighting the selected destination areas on the map; and (d) storing the selected destinations in a data storage device.

Yet another embodiment includes a computer-readable medium including executable instructions which, when executed by a processor, perform steps for processing travel-related information. The steps include: (a) displaying a map of a geographical region, wherein the geographical region includes a plurality of selectable destination areas; (b) enabling the user to select at least one of the travel destination areas; (c) highlighting the selected destination areas on the map; and (d) storing the selected destinations in a data storage device.

Still another embodiment includes a method for displaying travel-related options. The method includes: (a) displaying a map on a display device; (b) enabling a user to select at least a first location; (c) for each selected location, enabling a user to enter travel criteria; (d) displaying on the map, any locations other than the first location that meet the travel criteria; (e) enabling the user to change the travel criteria; and (f) while the user changes the travel criteria, updating the map to display any locations that meet the changed travel criteria.

Another embodiment includes a method for enabling a user to access travel-related account data through a plurality of different social networking websites. The method includes: (a) enabling a user to create an account for a software application which is accessible over a network, where the software application is hosted by and accessible through each of a plurality of different social networking websites; (b) enabling the user to produce account data associated with the account; and (c) enabling the user to store account data on a data storage device accessible over the network, wherein such data has been generated by the software application hosted on one of the social networking websites and transmitted by the same social networking website.

Yet another embodiment includes a method for comparing travel-related information over a network. The method includes: (a) displaying a first map associated with a first user and having a plurality of geographical regions, and graphically indicating a status associated with each geographical region; (b) enabling the first user to retrieve geographical map data through a software program hosted by a social-networking website, wherein the geographical map data is associated with a second user and includes the statuses associated with different geographical regions; and (c) displaying the first map and a second map together to the user simultaneously, wherein the second map graphically indicates statuses of geographical regions and based on the retrieved map data.

Still another embodiment includes a computer-readable medium including executable instructions which, when executed by a processor, perform steps for facilitating a group trip. The steps includes: (a) storing a personality profile associated with each of a plurality of users in a database; (b) designating a trip; (c) determining a travel compatibility threshold for the trip; (d) determining a travel compatibility value for each of the users based on the trip and based the personality profile of the user; (e) designating a group of potential travelers for the trip by filtering out the users whose travel compatibility values do not meet the travel compatibility threshold; (f) sending an invitation to join the trip to each of the potential travelers; (g) enabling any of the potential travelers to accept the invitation; and (h) forming a group of confirmed travelers based on any accepted invitations.

Another embodiment includes a method for providing reviews of places. The method includes: (a) storing data corresponding to a plurality of places on a database; (b) storing data corresponding to a plurality of personality profiles on the database, wherein each one of the personality profiles is associated with one of a plurality of users; (c) enabling a reviewer (which can be one of the users) to submit reviews of one or more places, wherein each review is associated with a personality profile of the reviewer; (d) storing the submitted reviews on the database; (e) enabling the users to filter reviews based on a degree of correspondence between the personality profile of the user and the personality profile associated with at least one of the reviewers. In one embodiment, the reviewer is one of the users.

Additional features and advantages are described herein, and will be apparent from, the following Detailed Description and the figures.

### BRIEF DESCRIPTION OF THE FIGURES

FIG. 1 is a schematic view of a network configuration for sharing travel-related information, in an embodiment.

FIG. 2 is a front view of a graphical user interface having a map for displaying travel-related information, in an embodiment.

FIG. 3 is a front view of a graphical user interface having a map for displaying travel-related information, in an embodiment.

FIGS. 4A, 4B, 4C and 4D are front views of a graphical user interface having a plurality of maps for comparing travel-related information, in an embodiment.

FIG. 4E is a graph indicating the quantity of travel-related options available at different price levels.

FIGS. 5A and 5B are a schematic views of a network configuration for accessing and updating travel-related information through several different social networking websites, in an embodiment.

FIG. 6 is a schematic view of a network configuration for planning a group trip, in an embodiment.

### DETAILED DESCRIPTION

### 1.0 System for Displaying Travel-Related Statuses of Geographical Regions

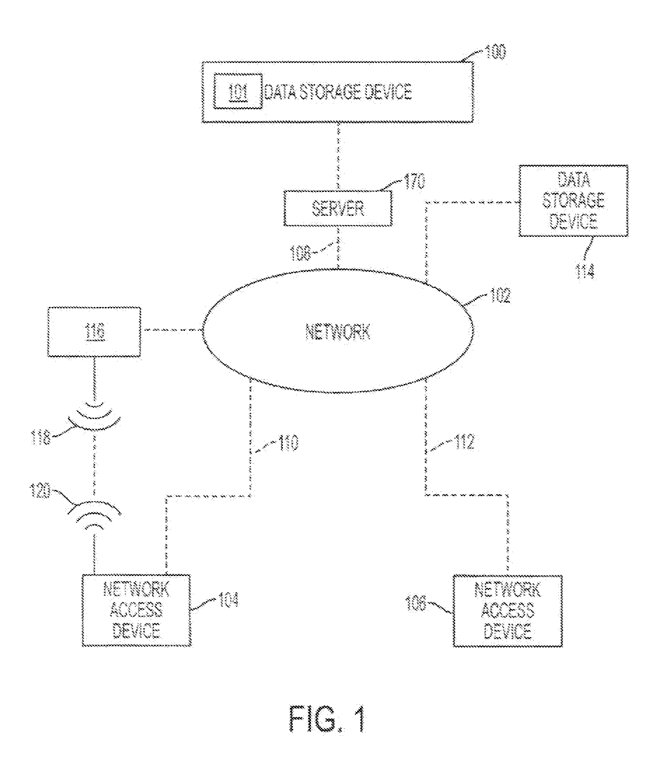

In one embodiment, as shown in FIG. 1, a method of sharing travel-related information over a network is provided. One or more network access devices 104 and 106 are connected to one or more data storage devices 100 and 114 over the network 102. The network 102 can be a local area network (LAN), a wide area network (WAN), the internet, or any other suitable data network. In one embodiment, the network access devices 104 and 106 include computers, laptop network access devices, handheld personal digital assistant (PDA) devices, cellular phones, or any other suitable computing platform which includes a display device (or other output device) and is capable of transferring and/or receiving data over the network 102. In one embodiment, the network access devices access the network through land-based data communication lines 110, 112 and 108. In another embodiment, the network access devices 104 and 106 are configured to transmit and receive data wirelessly through a transmitter/receiver 120 or other suitable wireless device. In one embodiment, a routing device 116 includes another transmitter/receiver 118 which receives the travel-related information sent from the computer 104. The routing device 116 then transmits the received data over the network 102 to the data storage device 100. The data storage device 100 can be a memory device such as a hard drive, a tape drive, or any other suitable data storage device.

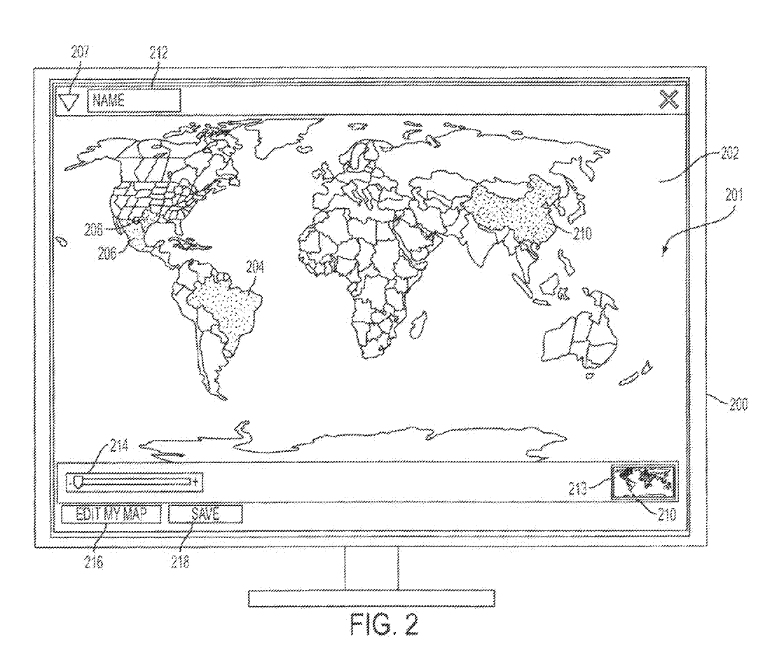

As shown in FIG. 2, in an embodiment, the data storage device 100 stores a travel-related information system 101. The travel-related information system 101 includes a plurality of computer-readable instructions which are accessible by one or more processors or servers 170. In one embodiment, the travel-related information system 101 includes a plurality of programming modules which control or direct the operation of the server 170. The server 170 executes the instructions of the modules to perform particular functions. In this disclosure, the modules may, at times, be described as performing certain functions. It should be understood, however, that the server 170 actually performs the functions of such modules by executing such modules. In this regard, the modules perform (or define the performance of) certain functions.

Each module includes a set of computer-readable instructions and data which are related to a designated function, purpose, subject matter or topic. This type of modular construction of the travel-related information system 101 can be created using any suitable computer programming language or database, including, without limitation, JAVA, C++ or SQL for specifying business logic and other functions. In another embodiment, the travel-related information system 101 is structured as a single module or single set of computer-readable instructions. In such case, this single set of computer-readable instructions has the functionality of the travel-related information system's 101 separate modules which are described in detail below.

In one embodiment, a method for sharing travel-relating information includes sharing the information over a network, as described with reference to FIG. 1. In operation, a user operating a network access device 104 or 106 communicates with the data storage device 100 and system 101 over the network 102. In one embodiment, the user retrieves (or downloads) a copy of the system 101 from the data storage device 100 over the network and locally installs the module onto the user's network access device 104 or 106. This locally installed system 101 is configured, at least in part, with map viewing functional. In another example, the system 101 is stored on the data storage device 100 and the system 101 is accessed by an Internet browser (or other data portal) on the user's network access device 104 or 106. In one embodiment, the user initializes the system 101 (or accesses the system 101 over the network 102) and transmits information identifying the user to the remote server 170. This could include logging on or sending user name and password information to the server 170. When the remote server 170 has authenticated the user information as valid, the system 101 retrieves travel-related information associated with the user from the data storage device 100.

In an example where a copy of the module is stored locally on the user's network access device 104 or 106, the system 101 causes the travel-related information associated with the user to be sent over the network 102, which is then received by the user's network access device 104 or 106. The module executes one or more functions to interpret the travel-related information and causes at least a portion of the information to be indicated to the user. In one example, the executed functions of the module cause the information to be indicated visually on the display device 200 in the form of a map 202. In this example, an indication of the status associated with each geographical region is also visually indicated on the map 202. As mentioned above, this indication can be a visual indication such as coloring or shading of the different geographical regions.

In the embodiment where the module is stored remotely on the data storage device 100 or server 107, the system 101, in response to a request from a network access device 104 or 106, retrieves travel-related information and generates other display information (such as HTML formatting tags) from the data storage device 100, and causes this information to be transmitted to the user's network access device 104 or 106. A web browser or other viewing module installed on the user's network access device 104 or 106 causes the received information to be interpreted and displayed to the user.

In one embodiment, the system 101 enables a user to identify other users and create a friends list, where the friends list can include friends, relatives, colleagues, associates, or other people known to the user. This friends list is also stored on the data storage device 100 and is accessible over the network 102. The system 101 enables the user to access at least a portion of the travel-related information associated with the other users, and caused this information to be displayed on a map. In another embodiment, the system 101 enables users to publicize their travel-related information to their own social network, to members of a different social network, or to the general public. Therefore, travel-related information for a plurality of users can be accessed and shared over a network.

In one embodiment, the travel-related information system 101 enables one or more network access devices 104 and 106 which include a display device 200, to display information in a graphical user interface (GUI) 201. The GUI 201 includes a world map 202 having several different selectable geographical regions including, but not limited to, regions 204, 206, 208 and 210. It should be appreciated that several or all of the countries, states or other bounded geographic regions displayed on the map 202 are selectable. In one embodiment, the travel-related information system 101 enables a user to select the geographical regions from a list (not shown). In other embodiments, the travel-related information system 101 enables the user to select the geographical regions with a mouse click or by using a touch screen device. In addition to displaying a map 202 having different selectable geographical regions, the travel-related information system 101 is configured to cause other inputs to be displayed on the display device 200. In one embodiment, the GUI 201 on the display device 200 includes a slider bar 214. The travel-related information system 101 enables the user to click and drag the slider bar 214. When the slider bar 214 is moved in one direction, the travel-related information system 101 causes the view of the world map 202 to zoom out. When the slider bar 214 is moved in a different direction, the travel-related information system 101 causes the view of the world map 202 to zoom out. For example, to view details of a small country, state, or other graphical region close up, the travel-related information system 101 enables the user to move the slider bar 214 to zoom in to view the particular region.

As shown in FIG. 2, in one embodiment, the display device 200 is configured to display a miniature world map 210. The travel-related information system 101 causes the miniature world map 210 to be displayed with a bounding box 213, which indicates the portion of the map 202 which is currently displayed on a different portion of the GUI 201. Therefore, if the map 202 is zoomed out fully, as it is in the example shown in FIG. 2, the bounding box 213 of the miniature world map 210 includes the entire area. However, if the slider bar 214 is moved to zoom into a smaller region of the map 202, the bounding box 213 of the miniature world map 210 would shrink to reflect the smaller area. In one embodiment, if the map 210 is zoomed in to a certain extent (i.e., where the bounding box 213 appears smaller in a portion of the miniature world map 210), the travel-related information system 101 enables the user to click and drag the bounding box 213 around within the boundary of the miniature world map 210. When the bounding box 213 is moved, the travel-related information system 101 causes the display device 200 to redisplay the portion of the larger map 202 to reflect the changed position of the bounding box 213. In one embodiment, when the bounding box 213 is moved, the portion of the larger map 202 moves in unison.

In an embodiment, if the large map 202 is zoomed in to a certain extent, the travel-related information system 101 also enables the user to click and drag the larger map 202 to view a different portion of this map 202. In one example, if the user has zoomed in to view only North America, the user can click and drag the map 202 to view a different portion of the map 202, such as South America. In this example, if the user clicks and drags the zoomed in map 202, the position of the bounding box 213 in the miniature world map 210 changes concurrently to reflect this new position.

In one embodiment, the travel-related information system 101 includes a display device 200 which is configured to display a user name input 212, an edit map input 216, and a save input 218. The user name input 212 displays the user name associated with the currently displayed map. In another embodiment, the user name input 212 is a drop down list 207 which includes at least the currently logged in user's name and one or more other user names. If the current user selects a different user name, the travel-related information system 101 causes the display device to display a new map. The new map indicates the statuses of the geographical regions that are associated with the second user. In one example, the travel-related information system 101 enables the current user to designate a friends list which will appear in the drop down list 207 of the user name input 212. Therefore, the travel-related information system 101 enables the current user to change the user name and view the different maps of the current user's friends. Accordingly, the travel-related information system 101 enables users to compare the statuses of the geographical regions between themselves and different users. In one embodiment, when the edit my map input 216 has been activated, the travel-related information system 101 causes the display device 202 to display an input form or to otherwise enable the user to change the statuses associated with the different geographical regions. In an embodiment, the save input 218 causes data corresponding to the geographical regions and the associated statuses to be stored on data storage device 100, as illustrated in FIG. 1.

In an embodiment, the travel-related information system 101 generates a plurality of travel-related statuses which can be associated with a particular geographical region. For example, the statuses can include the following statuses:

TABLE 1

| Geographic Region/ | | | Visual |
|---|---|---|---|
| Travel Site | Status Type | Status Meaning | Indicator |
| A | Visited | The user has previously traveled to | I1 |
| | | or visited the geographical region | |
| | | or travel site. | |
| B | To Be | The user desires to travel to or visit | I2 |
| | Visited | the region or site. | |
| C | Lived | The user previously lived in or | I3 |
| | | resided in the geographical region | |
| | | or travel site. | |
| D | Own/ | The user currently owns or has | I4 |
| | Owned | previously owned real estate | |
| | Property | property, such as a house, in the | |
| | | geographical region or travel site. | |
| E | Married | The user was married in the | I5 |
| | | geographical region or travel site. | |
| F | Alma Mater | The user attended and/or | I6 |
| | | graduated from a school, college, | |
| | | or university in the geographical | |
| | | region or travel site | |
| G | . . . X, Y, Z . . . | . . . X, Y, Z . . . | . . . I7, I8, I9 . . . |

Multiple geographical regions or travel sites can have the same status. In one embodiment, a single geographical region or travel site can have more than one status. Although six specific examples of statuses are given in Table 1 above, it should be appreciated that the travel-related information system 101 can provide a variety of other statuses, as generally indicated by the . . . X,Y,Z . . . table entry.

In the example shown in FIG. 2, the initial status of each geographical region or travel site is unassigned. If a particular geographical region is selected, the travel-related information system 101 causes the status associated with the region to change to a first status. The first status could be, for example, a past travel destination. If the same geographical region is selected again, the status associated with the region is changed to a second status. The second status could be, for example, a desired future travel destination. If the same geographical region is selected a third time, the system 101 causes the status associated with the region to be changed to a third status. The third status could be, for example, a destination that the user has once lived. If the same geographical region is selected a fourth time, because there is not a fourth status, the system 101 causes the status associated with the region to be changed back to the unassigned status. Therefore, with each click or selection of the geographical region, the processor causes the status associated with the region to cycle through an array of possible statuses, as shown in the following status table:

TABLE 2

| Click/Selection | | | Visual |
|---|---|---|---|
| Iteration | Status Type | Status Meaning | Indicator |
| 0 | Unassigned | The user has not assigned any status to | I0 |
| | | this geographical region or travel site. | |
| 1 | Visited | The user has previously traveled to or | I1 |
| | | visited the geographical region or travel | |
| | | site. | |
| 2 | To Be | The user desires to travel to or visit the | I2 |
| | Visited | region or site. | |
| 3 | Lived | The user previously lived in or resided in | I3 |
| | | the geographical region or travel site. | |
| 4 | Unassigned | The status returns to the original state of | I0 |
| | | unassigned. | |
| 5 | Visited | The user has previously traveled to or | I1 |
| | | visited the geographical region or travel | |
| | | site. | |
| 6 | To Be | The user desires to travel to or visit the | I2 |
| | Visited | region or site. | |

Although, in the example given above, there are only four statuses (i.e., unassigned, a past travel destination, a desired future travel destination, or a destination that the user has once lived), it should be appreciated that the system 101 is operable to provide any number of statuses. The other statuses may include, but are not limited to, other travel-related information such as identities of co-travelers to destinations (e.g., cities, towns, hotels, restaurants etc.) within the geographical region, financial data associated with a trip, notes or reviews about the destination (discussed in further detail below), or any other suitable information or status. The user may also associate certain data files with a geographical region, such as image files. In one example, the system enables the user to store or upload pictures of a trip which other users can access over the network.

As shown in FIG. 2, in one embodiment, the system 201 generates a plurality of indicators associated with the different statuses. When the travel-related status of a particular geographical region is changed, the system 201 causes a redisplay of the geographical region with a different visual indication, such as changing the shading from a type shown in geographical region 206 to a different type shown in geographical region 210. In another example, when the status is changed, the system 201 causes the background color of the geographical region to change to a different color. In another example, the system 201 causes a different shading or stippling to be applied. In the example shown in FIG. 2, the system 201 causes a first status and a first shading type to be displayed for countries 206 and 204. This can indicate that these are countries that a user has visited in the past, for example. As also shown in FIG. 2, the system 201 causes a second status and a second shading type to be displayed for countries 208 and 210. This can indicate that these are countries that the user has lived in the past, for example. In one embodiment, it is possible to associate more than one status with a particular geographical region.

### 2.0 System for Comparing Travel-Related Information of Multiple Users

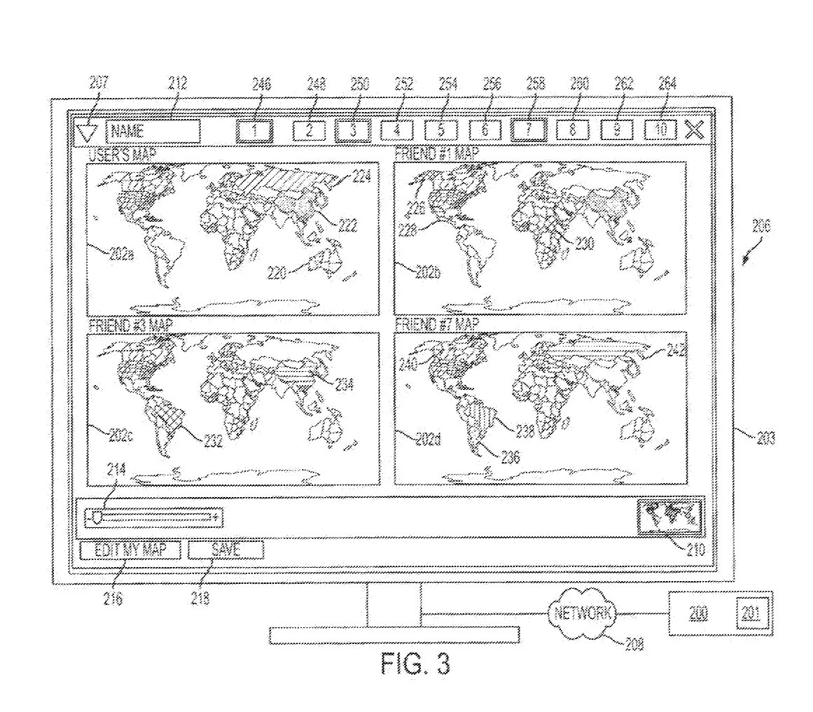

In one embodiment, as shown in FIG. 3, a method of comparing travel-related information over a network 202 is provided. A network access device 206 includes a display device 203 which is configured to display certain visual elements, as discussed above with reference to FIG. 2. The network access device 206 is configured to display a user name input 212, an edit my map input 216, a save input 218, a zoom slider bar 214, and a miniature world map 210. Other suitable inputs or display elements may be included. In this embodiment, the system 201 includes functions, that when executed, cause the display device 203 to display a plurality of different user selectable icons 246 to 264. The user icons 246 to 264 may include an image of the user, a user selected avatar, the user name, or other suitable user identifying information. As mentioned above, the system 201 enables each user to designate a friends list and store this list on a remote data storage device 200, as illustrated in FIG. 3. In one embodiment, the system 201 causes a user icon to be displayed on the display device 203 for each of the users in the designated friends list. Therefore, if the current user has a friends list with ten friends (as in the example shown in FIG. 3), the system 201 causes ten user icons 246 to 264 to be displayed. In this embodiment, each of the user icons 246 to 264 are selectable. When a current user selects a different user icon, the system 201 causes the travel-related information associated with the selected user icon to be retrieved from the data storage device 200, and causes this information to be displayed on the display device 203.

In the example shown in FIG. 3, the system 201 causes the display device 203 to display a plurality of different maps 202a, 202b, 202c and 202d, where one of the maps 202a includes travel-related information associated with the current user, and each of the remaining maps 202b, 202c and 202d includes travel-related information associated with each of the selected friends, as also indicated by activated user inputs 246, 250 and 258. The system 101 causes each of the maps 202a, 202b, 202c and 202d to display indications of the travel-related status for each of the geographical regions. In user map 202a, the system 201 causes geographical regions 224 and 222 to be highlighted with dots to indicate a first travel-related status associated with these geographical regions. The system 201 causes geographical region 224 to be highlighted with diagonal lines to indicate a second travel-related status associated with that region. In user map 202b (i.e., the map for Friend #1) the system 201 causes geographical regions 226 and 230 to be highlighted with crosshatching to indicate a third travel-related status associated with those regions. The system also causes geographical region 228 to be highlighted with horizontal lines to indicate a fourth travel-related status associated with that region. In user map 202c (i.e., the map for Friend #3) the system causes geographical region 232 to be highlighted with crosshatching to indicate that the third travel-related status is associated with those regions. Geographical region 232 is highlighted with horizontal lines to indicate that the fourth travel-related status is associated with that region. In user map 202d (i.e., the map for Friend #7) geographical region 240 is highlighted with crosshatching to indicate that the third travel-related status is associated with that region. Geographical region 242 is highlighted with horizontal lines to indicate that the fourth travel-related status is associated with that region. Geographical region 238 is highlighted with vertical lines to indicate that a fifth travel-related status is associated with that region. Geographical region 236 is highlighted with dots to indicate that the first travel-related status is associated with that region. Any suitable number of different friend's maps can be displayed. The visual indications can include dots, lines, and crosshatching as discussed above, and can also include other visual indications such as shading, color, text and animation.

In the embodiment shown in FIG. 3, multiple maps are displayed adjacent to one another. In another embodiment, different user maps can be overlaid on top of one another (not shown). In this map overlay embodiment, any of the geographical regions which have been selected by multiple users will indicated multiple travel-related statuses. For example, if friend map 202c were to be overlaid on top of the friend's map 202a, multiple statuses would be indicated for country 222, 234. Although a side-by-side map comparison and an overlay map comparison are discussed above, the comparison of different users' travel-related information can be displayed in alternative manners.

### 3.0 Method for Dynamically Displaying Travel-Related Pricing Information

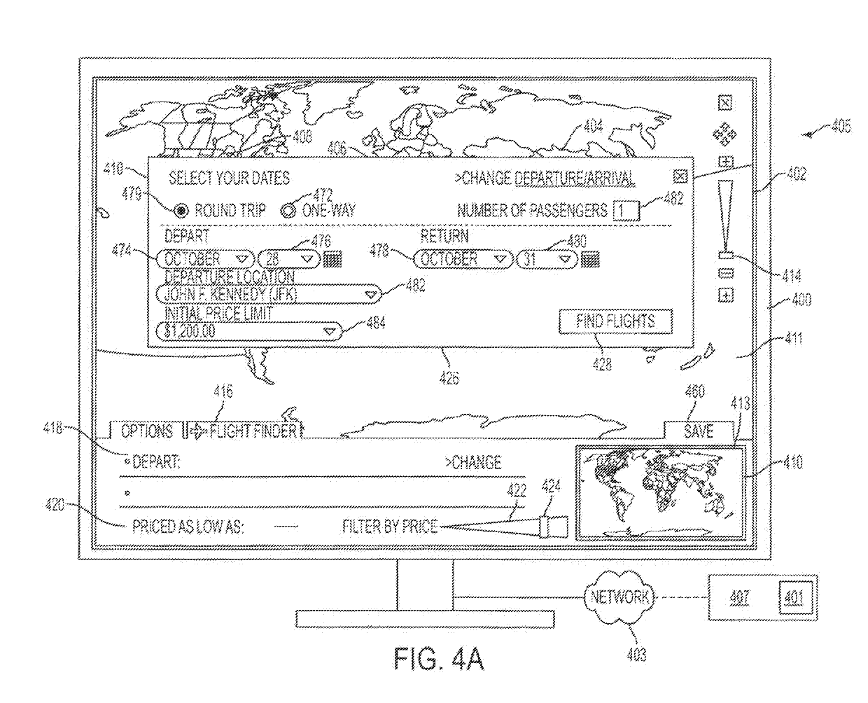

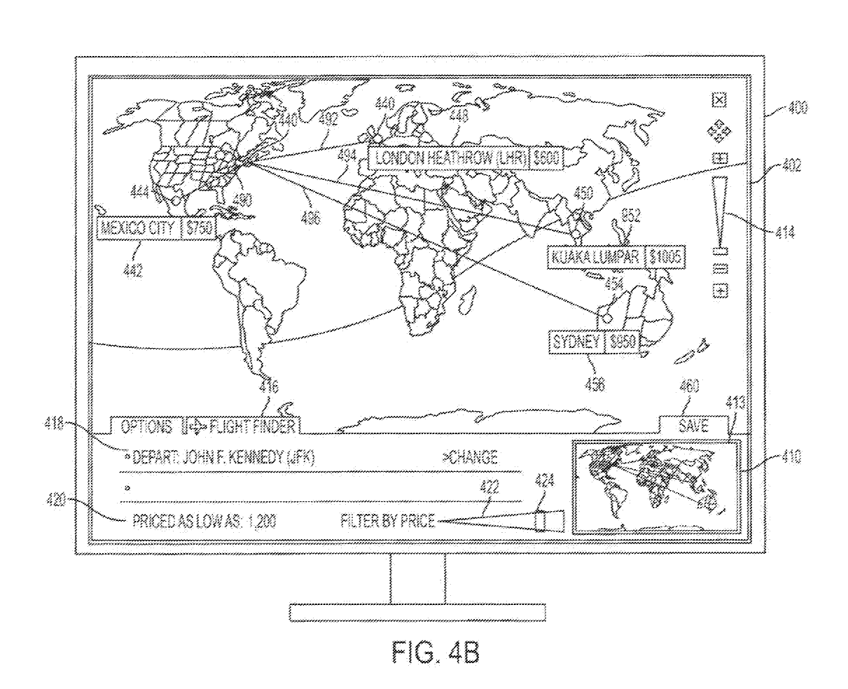

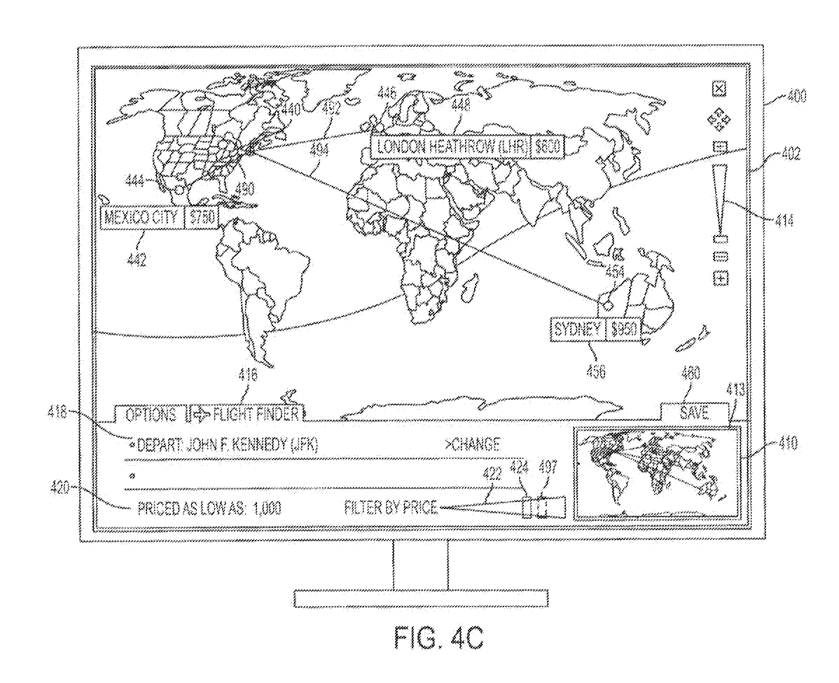

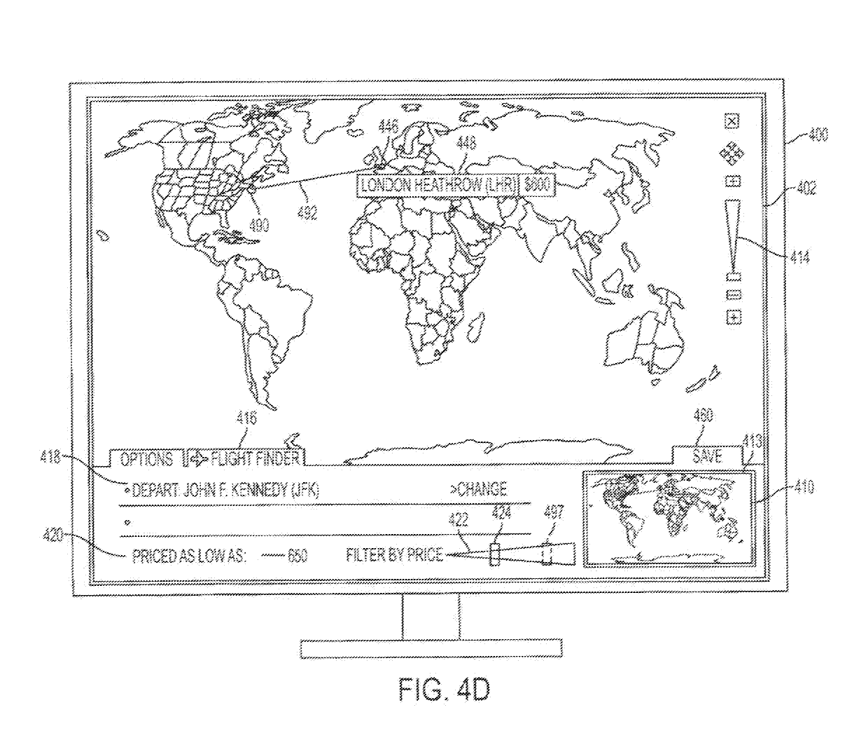

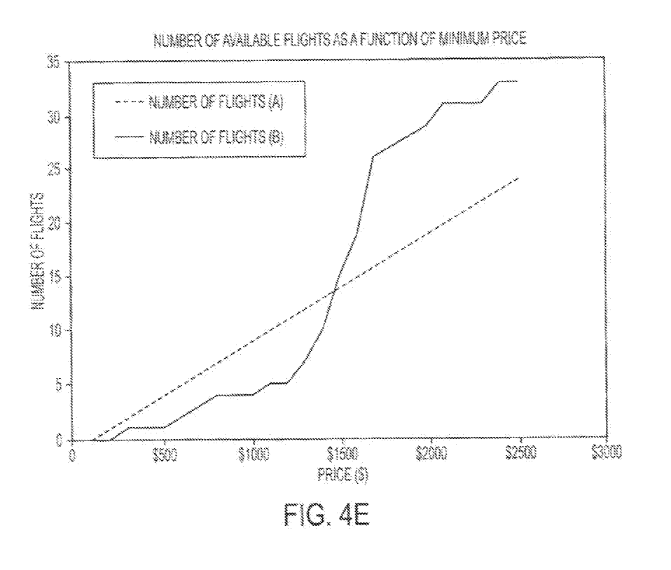

In one embodiment, as shown in FIGS. 4A, 4B, 4C, 4D and 4E, a method of dynamically displaying travel-related pricing options is provided. As shown in FIG. 4A, in an embodiment, a network access device 405 includes a display device 400 having a graphical user interface (GUI) 411 which is configured to display a map 402 having several different geographical regions 404, 406, 408 and 410. It should be appreciated that several or all of the countries, states or other bounded geographic regions may be displayed on the map 402. In one embodiment, the system 401 enables a user to select a travel origin from a list 482. In other embodiments, the system 401 enables a user to select a travel origin with a mouse click or by using a touch screen device of the network access device 405. In addition to displaying a map 402 having different geographical regions, the system 401 causes the display device 400 to display other inputs and graphical elements in the GUI 411. In one embodiment, the GUI 411 includes a zoom slider bar 414. The system 401 enables a user to click and drag the slider bar 414 to zoom the map 402 in or out. For example, if the user would like to select a very small country, state, or particular airport within a state, the slider bar 414 is slid to zoom in to a close up view of the particular geographical region or travel destination. In one embodiment, the GUI 411 includes a miniature world map 410, similar to the world map 110 described above with respect to FIG. 2. The miniature world map 410 is displayed with a bounding box 413 which indicates the portion of the map 402 that is currently displayed. As described above, if the map 402 is zoomed out fully, as it is in the example shown in FIG. 4, the bounding box 413 of the miniature world map 410 would include the entire map area. However, if the slider bar 414 is slid to zoom into a smaller region of the map 402, the system 401 causes the bounding box 413 of the miniature world map 410 to shrink to reflect the smaller geographical viewing area. In one embodiment, the system 401 enables the user to click and drag the bounding box 413 or the main map 402, as described above. The GUI 411 includes a save input 460, and the system 401 enables a user to save search results to a remote data storage device 407, as discussed below.

As shown in FIG. 4A, the GUI 411 further includes a flight information area 416, a departure location information area 418, a pricing information area 420, a price filter slider bar 422, and a price filter slider 424. In operation, the system 401 causes the display device 400 to display the map 402, to display the inputs discussed above, and to display a travel criteria selection form 426. In the example shown in FIG. 4A, the system 401 causes the travel criteria selection form 426 to be displayed as a pop-up window which is overlaid above the main map 402 window. However, the travel criteria selection form 426 may also be displayed in a portion of the main map 402 window, or in another suitable position. After the system 401 has caused the display device 400 to display the travel criteria selection form 426, the system 401 prompts the user to enter different search criteria. As shown in FIG. 4A, the travel criteria selection form 426 includes a number of inputs for different search criteria. In this example, the inputs include a round trip input 470, a one-way input 472, a number of passengers input 482, a departure month input 474, a departure day input 476, a return month input 478, a return day input 480, a departure location input 482, an initial price limit input 484, and a find flights input 428. The departure location input 482 includes a plurality of airports. The system 401 enables a user to select a single departure location or place of origin, and to enter the remaining search criteria which will be used by the system 401 to search for available flights. In another embodiment, the system 401 enables the user to enter more than one departure location. This may be useful for cities which include more than one airport. As shown in the example in FIG. 4A, the selected search criteria include: (a) a single round trip ticket for one passenger; (b) having a departure date of October 28; (c) having a return date of October 31; and (d) departing from John F. Kennedy (JKF) airport in New York. The initial price limit is set at $1,200.00. Therefore, the search results will only include airline tickets which cost $1,200.00 or less. After the search information has been entered into the travel criteria selection form 426, the system 401 enables the user to activate the find flights input 428 to initiate the search. Other suitable travel criteria may be included on the travel criteria selection form 426, such as a range of departure dates, a range of return dates, preferred accommodations, preferred rental car companies, and other suitable travel-related criteria.

After the find flight input 428 has been activated, the system 401 receives the selected travel criteria information from the form data that was sent over the network 403. The system 401 uses the travel criteria information to perform a search of available flights matching the user's available travel-related criteria. In one embodiment, the travel-pricing information (e.g., flights) is retrieved over the network 402 from a plurality of different servers, where each server includes current flight data for a particular travel provider (e.g., an airline company). In another embodiment, travel pricing information is retrieved over the network 403 from a single server hosted by a third party, where the third party consolidates travel pricing information from various travel providers.

As shown in FIG. 4B, after the system 401 has completed the search based on the user entered travel-related criteria, the system 401 causes the search result information to be sent to the user's network access device 405. The system 401 interprets the received information and causes the information to be displayed on the map 402, as discussed below. As shown in FIG. 4B, the initial search results include four flights that match the entered travel criteria. In the embodiment shown in FIG. 4B, the departure location is indicated by a dot 440. Each of the destination locations are also indicated by dots 446, 444, 450 and 454. In one embodiment, the GUI 411 also includes lines 490, 492, 494 and 496 connecting the departure location 440 with each of the possible destinations 444, 446, 450 and 454. Adjacent to each of the possible destinations is a display of the destination location and the price of the round trip airline ticket. In particular, display area 442 includes the destination 444 of Mexico City and a ticket price of $750.00, display area 448 includes the destination 446 of London Heathrow and a ticket price of $600.00, display area 452 includes the destination 450 of Kuala Lumpur and a ticket price of $1,005.00, and display area 456 includes the destination 454 of Sydney and a ticket price of $950.00. The pricing information area 420 indicates that the current pricing threshold is set at $1,200.

In one embodiment, the slider 424 on the slider bar 422 is positioned to allow both upward and downward price adjustments. If the slider 424 is moved to the right along the slider bar 422, the system 401 causes the pricing threshold to increase and the number of possible destinations displayed will typically increase. On the contrary, if the slider 424 is moved to the left along the slider bar 422, the pricing threshold decreases and the number of possible destinations displayed will typically decrease. In response to the user's movement of the slider bar 422, the system automatically performs the indication of the change (increase or decrease) in the number of destinations. Also, in one embodiment, the system performs such automatic indication simultaneously with (and in proportion to) the movement of the slider bar 422. An example graph reflecting different price thresholds relative to the number of available travel options is shown in FIG. 4E.

As shown in FIG. 4E, as the minimum price level for an airline ticket increases, the number of flight options generally increases as well. In one example, indicated by the dashed line (A) in FIG. 4E, the number of flight options increase in a generally linear manner to the minimum price of the ticket. In another example, as indicated by the solid line (B) in FIG. 4E, the number of flight options increases in a staggered and nonlinear manner. In the example shown by solid line (B), there is relatively little change in the number of available flight options between $0 and $1,250. However, when the minimum price is increased above $1,250 the number of available flights increases more dramatically.

Referring to FIG. 4C, the slider 424 has been moved from the original position 497 shown in FIG. 4B to a position further to the left. Therefore, the pricing threshold has been reduced to $1,000, as also indicated in the pricing information area 420. Because the price of the airline ticket to Kuala Lumpur (i.e., $1,005) was above the new price threshold of $1,000, this flight option is no longer displayed. Similarly, as shown in FIG. 4D, the slider 424 has been moved from the second position to a position even further to the left. Therefore, the pricing threshold has been further reduced to $650, as also indicated in the pricing information area 420. Because the price of the airline tickets to Sydney (i.e., $950) and to Mexico City (i.e., $750) are above the further lowered price threshold of $650, these flight options are no longer displayed. Accordingly, the only remaining flight option is between the origin location 440 John F. Kennedy airport, and the possible destination 446 of London Heathrow.

Referring to FIGS. 4B, 4C, and 4D, in an embodiment, the system 401 causes the available flight options to appear and disappear nearly concurrently with the movement of the slider 424 along the slider bar 422. That is, as the user drags the slider 424 to the left or right, there will be an immediate visual indication to the user of the effect of the changing price threshold on the available travel options. Accordingly, a method for dynamically displaying travel-related options to a user is provided. This enables a user to quickly discover what the effects are of varying the pricing threshold on the quantity of available travel options.

Although the embodiment described above with respect to FIGS. 4A to 4D has been described with respect to airline ticket prices, the same principal can also be applied to other travel-related data, such as hotel pricing data, restaurant pricing data, travel times, or with regard to other user settable criteria such as entertainment or risk level preferences. In one embodiment, multiple slider bars may be included in the display. For example, if the user sets a range of departure dates to be a single day, a second slider bar can be included that would widen the range of departure dates to two, three, four, or more than four. In this example, for a given pricing threshold, if the user moves the departure date range slider to increase the date range, the number of possible travel destinations would be expected to generally increase. One, two, or more than two different slider bars can be used, where each slider bar can be moved to change the searching criteria.

### 4.0 Cross Social-Networking-Platform User Identification Sharing Method

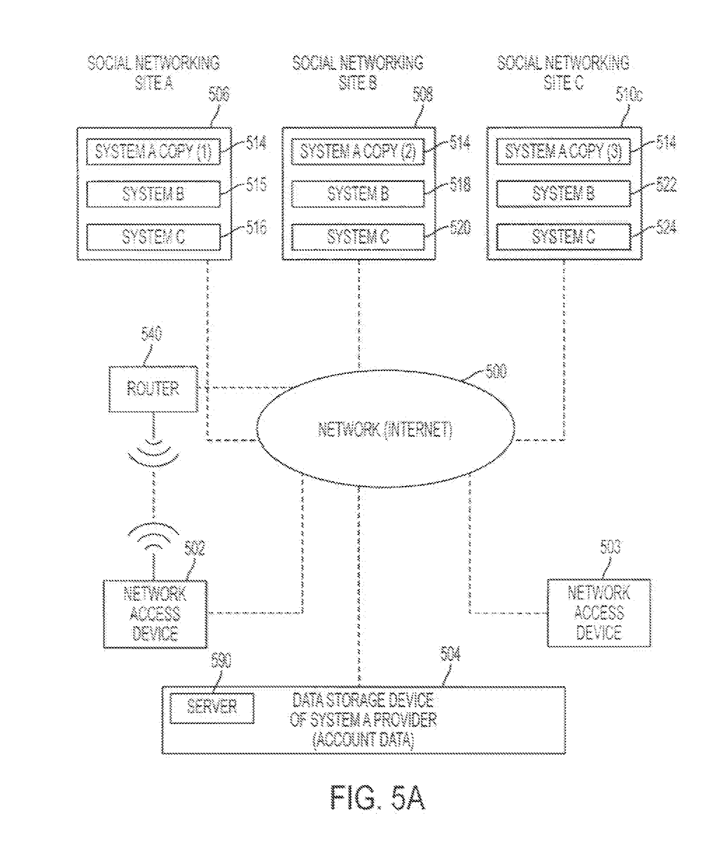

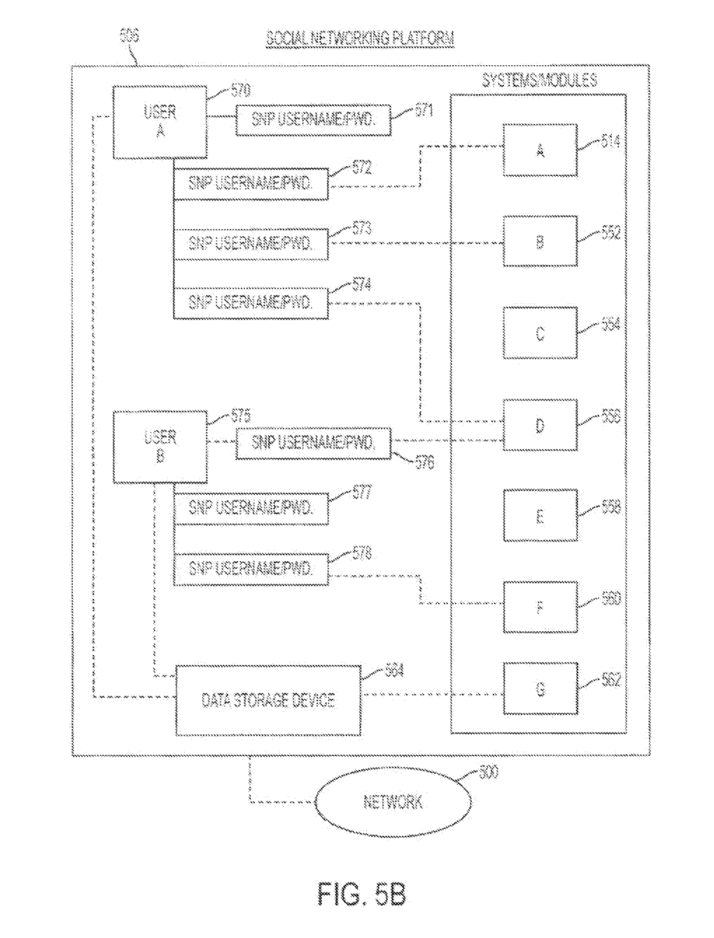

In one embodiment, as shown in FIGS. 5A and 5B, a method of enabling a user to access account data through a plurality of different social networking websites is provided. In this embodiment, a user operating a network access device 502 or 503 is able to access one or more different systems 512, 514, 516, 518, 520, 522 and 524 which are hosted on one or more different social networking websites 506, 508 and 510. As shown in FIG. 5A, each of the different social networking websites 506, 508 and 510 are capable of hosting one or more different systems. In the example shown in FIG. 5, a first social networking website 506 hosts system (A) 514, system (B) 515, and system (C) 516. A second social networking website 508 also hosts system (A) 514, system (B) 518, and system (C) 520. Finally, a third social networking website 510 hosts system (A) 522, system (B) 524, and system (C) 514 as well. Each of the three social networking websites 506, 508 and 510 host a separate copy of system (A) 514 (i.e., system (A,1), system (A,2), and system (A,3)), which is provided, for example, by a third-party software provider. A data storage device 504 is connected to each of the social networking websites or platforms 506, 508 and 510 over the network 500. In this example, the data storage device 504 is operated by the provider of system (A) 514. Because the provider of system (A) 514 has provided a copy of the system (A) 514 to a plurality of different social networking platforms, a single user could access or use the system (A) 514 from one or more of these social networking platforms.

In one embodiment, as shown in FIG. 5B, a social networking website or platform 506 is connected to the network 500 and includes data storage device 564. This data storage device 564 is distinguishable from the data storage device 504 operated by the provider of system (A) 514. Data storage device 564 is configured to store a plurality of different systems as well as user account information for a plurality of users. In the example shown in FIG. 5B, the social networking platform 506 hosts system (A) 514, system (B) 552, system (C) 554, system (D) 556, system (E) 558, system (F) 560, and system (G) 562. The social networking platform 506 also includes user account information for user (A) 570 and for user (B). The social networking platform 506 can include user account information for any suitable number of users. In one embodiment, the user account information includes a social networking username and social networking password. The password/username 571 identifies user (A) 570 and the password/username 576 identifies user (B). These password/usernames enable these users to login to the social networking platform 506 and subscribe to one or more of the available systems. In one embodiment, each of the systems 514, 552, 554, 556, 558, 560 and 562 are provided by different system providers. Moreover, as shown in FIG. 5A, the provider associated with system (A) 514 includes their own data storage device 504, as discussed above.

In this embodiment, in order to upload or download user specific information from or to data storage device 504 through the social networking platform 506 (or other of the social networking platforms 508 and 510), an additional username and password is required in addition to the username/password 576 of the social networking platform 506. As shown in FIG. 5B, user (A) 570 has subscribed to three different systems 514, 552 and 556. Accordingly the social networking platform 506 enables user (A) 570 to store username/password 572,573,574 information for each of the systems on data storage device 564, as indicated by the dashed lines connecting user (A) 570 to data storage device 564. Similarly, social networking platform 506 enables user (B) to store username/password 577,578 information on data storage device 564. In addition, at least with regard to system (A) 514, social networking platform 506 causes username/password 572 information for user (A) 570 to be transmitted over the network 500 to the data storage device 504 of the provider of system (A) 514. Accordingly, both the social networking platform 506 and the provider of system (A) 514 have username/password 572 information of user (A) 570.

In one embodiment, social networking platform 506 enables user (A) 570 to log in to their account on social networking platform 506 using username/password 571. Social networking platform 506 then enables the user to select use of one or more systems. If the user selects system (A) 514 the social networking platform 506 queries the data storage device 564 to see if a username/password has been stored for the user and that is associated with system (A) 514. If a username/password is found, then the social networking website and/or system (A) 514 transmits the retrieved username/password 572 over the network 500 to data storage device 504 of the provider of system (A) 514. Accordingly, if the user has already registered a username/password for a particular system, the user will only be required to login to the social networking platform 506 with username/password 571 and will not be required to login a separate time to access data on data storage device 504.

In one embodiment, system (A) 514 includes a software module for sharing travel-related information between a plurality of users over the network 500. As shown in FIG. 5A, the provider of system (A) 514 provides a data storage device 504 which is linked to each of the different social networking platforms 506, 508 and 510 over the network 500. The data storage device 504 stores information related to the travel information of the different users. When the server 590 verifies the user's login information (e.g., from username/password data transmitted from one of the social networking platforms), the server 590 connected to data storage device 504 queries data storage device 504 for information associated with the user and then causes the travel-related information associated with the user to be transferred back to the social networking website. After the social networking platform receives the information from the data storage device 504, system (A) 514 processes the information to generate and display a map which includes the travel-related information of the user. As mentioned above, the user can also request travel-related information of other users in order to do a comparison of the travel-related data. When the user interacts with system (A) 514 to update the user's travel-related information, system (A) 514 and social networking website 506 cause information regarding the updated user's travel-related data to be transmitted to data storage device 504 over the network 500. Accordingly, because the user's travel-related information is stored on the data storage device 504 of the provider of system (A) 514 rather than on the data storage device 564 of the social networking platform 564, the user can access their travel-related data by logging in to any of the different social networking websites 506, 508 and 510 which are shown in FIG. 5. In one embodiment, if the user logs in to a different one of the social networking platforms 508 and accesses a different copy of system (A) 514 for the first time, the user must enter the same username/password 572 as described above. It should be appreciated that different social networking platforms may have different policies or procedures regarding storing username/password information for different user system accounts. For example, a social networking platform may only store the username/password information for a temporary period of time.

In one embodiment, if a user has subscribed to system (A) 570 on more than one social networking platform, and changes their username/password 572 information while logged in to a first one of the social networking sites, the system (A) 570 causes this information change to be transmitted over the network 500 to the data storage device 504. In this embodiment, data storage device 504 includes user information that identifies all of the social networking platforms where the user has subscribed to the system (A). Because the data storage device 504 includes this information, when the username/password change is submitted from a first social networking platform, the server 590 and data storage device 504 causes the new username/password information to be retransmitted to each of other social networking platforms. Accordingly, if the user changes their system (A) 514 login information while accessing a first one of the social networking platforms 506, the password/username change will be populated to the remaining social networking websites 508 and 510. Thus, when a user accesses a different copy of system (A) 514 on a different one of the social networking platforms 510, they will not be required to update their password again.

### 5.0 Group Trip Planning

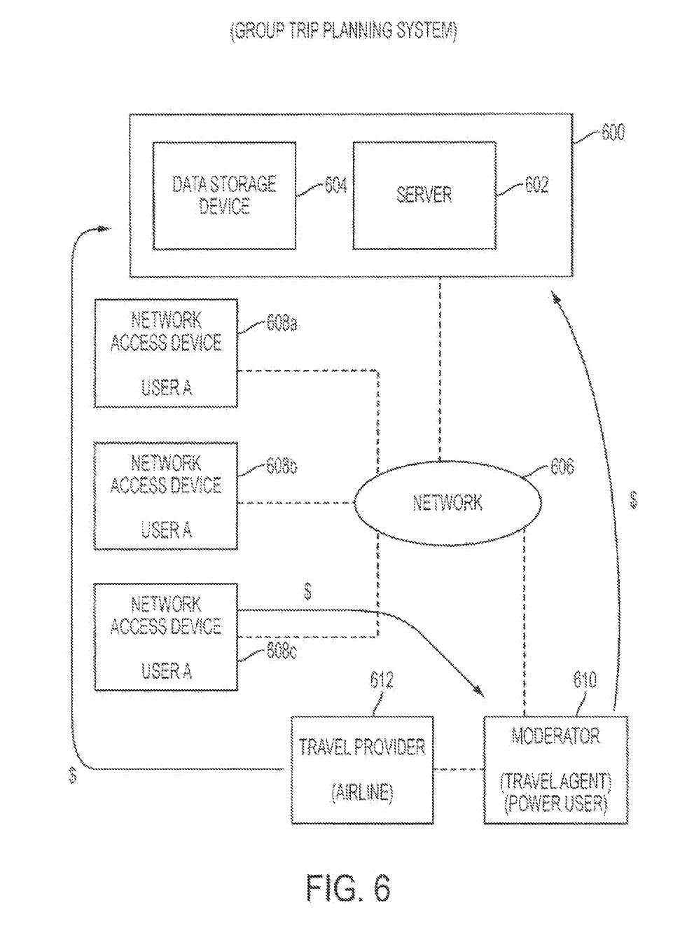

As shown in FIG. 6, a method for facilitating a group trip includes storing user personality profiles in a data storage device 604, and sending invitations to join the trip to different registered users based on a trip profile, and the degree of correspondence between the trip profile and personality profiles of the different users. As shown in FIG. 6, a group trip planning system 600 includes a server 602 which is connected to a data storage device 604. A plurality of users 608a, 608b and 608c can access and use the system 600 over the network 606. In one embodiment, the users enter information regarding their personality characteristics or other travel-related preferences by answering certain questions provided by the system 600. Based on the user's response to certain questions, the system 600 generates a travel personality profile of the user and causes this profile to be stored in a data storage device 604. For example, certain travelers may be on a tight budget, whereas other travelers can spend large amounts of money. Putting these two different travelers together in the same group trip may not be appropriate. In another example, one traveler may enjoy outdoor activities such as camping and hiking, whereas another traveler may prefer shopping and/or staying in a fancy or expensive hotel. Accordingly, based on a plurality of responses from a plurality of different users, the system 600 stores a variety of data to form a travel personality profile for each of the participating users 608a, 608b and 608c.

As shown in FIG. 6, in an embodiment, the method of planning a group trip includes allowing a moderator 610, such as a travel agent, to create or initiate a trip. The trip can include such parameters as trip duration, time of year, destination, estimated costs, preferred age category, gender bias, activities, risk level, and various other parameters. The moderator 610 works as a middleman between a travel provider (such as an airline or a charter bus company) and the group of potential travelers. However, instead of sending a general invitation to every user registered with the system 600, the moderator 610 uses the software application 602 to generate a trip profile. Then, the system 600 generates a travel compatibility threshold and filters out the potential travelers who do not meet or exceed this travel compatibility threshold. For example, if a trip is a mountain climbing expedition in the Swiss Alps, the trip profile may indicate that a high risk level and high degree of physical exertion is required. A user who has a preference for low risk activities would likely not meet the travel compatibility threshold for this particular trip. Accordingly, the larger pool of potential travelers is filtered down to a smaller group of users who have a personality profile which corresponds to a certain degree with the nature of the trip. The system 600 retrieves a list of filtered users and then sends each of the users an invitation to join the trip. When the maximum number of people allowed for the trip has been reached, the system 600 causes invitations to close. In one embodiment, the moderator may form a contract with the travel provider to perform the trip organization services for a specified fee, as shown in FIG. 6. Also, because the provider of the group trip planning system 600 has provided both a software platform and use of the data storage device 604, the system 600 provider may also contract with either or both of the trip moderator and the travel provider for a fee as well, as shown in FIG. 6. In another embodiment, the system 600 provider is the trip moderator. In another embodiment, a user is the trip moderator. In this way, the user can base the trip on their own personality profile and only invite users or friends whom they believe will have similar interests and travel expectations.

### 6.0 Method for Filtering Reviews Based on Personality Profiles

In an embodiment, a method of providing reviews for travel destinations, restaurants, hotels, and other venues includes enabling a user to filter available reviews according to a degree of correspondence between the user's personality profile and the personality profiles of the different reviewers. In this embodiment, a user can access reviews which are stored on a data storage device over a network. This type of system is similar to the users 608a, 608b and 608c, network 606, and data storage device 604 configuration shown in FIG. 6. In this embodiment, the system 600 enables a reviewer to answer a series of questions in order to generate information to form a reviewer personality profile. These questions may be similar or different from the questions used to develop the travel personality profile discussed above with regard to the group trip planning embodiment. The system 600 causes the personality profiles to be stored on a data storage device 604. Once a reviewer has created their personality profile, they are able to submit various reviews which are also stored on the data storage device. The system 600 enables a data link between the submitted reviews and the personality profile of the reviewer. Accordingly, for each review submitted, there exists an associated personality profile to indicate the likes, dislikes, or other personality traits of the person who submitted the review, an example of which is shown below:

TABLE 3

| Travel Destination/ | | |
|---|---|---|
| Places | Reviewer | Reviewer Profile Characteristics |
| French Riviera | 1 | A, D, X, Y, Z |
| French Riviera | 2 | B, C, R, T, X, Y, Z |
| Amazon Jungle | 3 | B, C, Z |
| Antarctica | 4 | A, D, F, T, S |

In this example table, there are two reviews by two different reviewers for the French Rivera, namely Reviewer 1 and Reviewer 2. With regard to Reviewer 1, he/she has associated profile characteristics A, D, X, Y, Z. These characteristics can include such traits as wealth level, risk aversion, sports enthusiast, etc. On the other hand, Reviewer 2 includes certain different profile characteristics B, C, R, T, X, Y, Z. In this embodiment, if a user that is searching for reviews has profiles characteristics that include most of B, C, R, T, X, Y, Z, then it would be likely that the Reviewer 2's review of the French Riviera would be returned in a search due to the degree of correspondence between the searching user's personality profile and the reviewer's personality profile.

In this embodiment, other users are also able to generate their own personality profiles and store them on the data storage device. The system includes a graphical user interface (not shown) which enables a user to search for previously submitted reviews based on a number of criteria. These criteria can include the dates, locations, review categories, and other factors. Also, the criteria includes a measure of degree of correspondence between the personality profile of the user and the different personality profiles associated with the different reviews. Therefore, the system 600 enables a user to search for reviews where the reviewer has similar personality characteristics to the user. For example, if the personality profile associated with review indicates that the reviewer enjoys very spicy food, and the personality profile of the searching user indicates that the user enjoys only bland food, the search criteria may filter out any food reviews by this particular reviewer.

In an embodiment, a reviewing system is provided as discussed above, and further includes a rating and reward system. With regard to the rating system, after a review has been submitted, the system enables other users to rate the particular review. For example, if the reviewing user disagrees with the review, they can give the review a low rating. In addition to the search criteria discussed above, users can also search for reviews based on an average review rating or based on the total number of times a review has been rated. Therefore, users are able to filter out reviews that are rated poorly. With regard to the reward system, the system 600 provides a reviewer with a benefit based, at least in part, on the number of reviews submitted, the average rating of the review, the quality of the review, or the number of times a review has been read. The system 600 stores statistics related to each reviewer in the data storage device 604 and determines whether or not a reward should be provided to the reviewer based on their past submissions. The rewards can include one or more of a coupon, a monetary award, a travel discount, or redeemable reward points. In an embodiment, the system 600 associates a reviewer rating or a reviewer status to each reviewer. For example, a particular reviewer could be considered to be a power reviewer if they have submitted a specified number of reviews in given period of time. In another example, the reviewer could be rated high if the reviewer's reviews have been rated highly or read a large number of times by other users. Accordingly, an award may also be provided to a reviewer having a sufficiently high reviewer status.

One embodiment of the present disclosure includes any suitable or functional combination of any of the embodiments described above. Another embodiment of the present disclosure includes any suitable or functional combination of any of the elements of any of the embodiments described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for providing reviews of places, said method comprising:
(a) storing data corresponding to a plurality of places on a database;
(b) storing data corresponding to a plurality of personality profiles on the database, each one of the personality profiles associated with one of a plurality of users;
(c) enabling a reviewer to submit reviews of at least one of the places, each review associated with a personality profile of the reviewer;
(d) storing the submitted reviews on the database; and
(e) enabling the users to filter reviews based on a degree of correspondence between the personality profile of the user and the personality profile associated with at least one of the reviewers.

2. The method for providing reviews of claim 1, including providing a benefit to each user who submits a review.

3. The method for providing reviews of claim 2, wherein the benefit includes at least one of: a coupon; a monetary reward; a travel discount; and redeemable reward points.

4. The method for providing reviews of claim 1, including enabling the users to rate at least one of any previously submitted reviews.

5. The method for providing reviews of claim 1, including enabling the users to search for reviews based on users who have previously submitted a designated number of reviews.

6. The method for providing reviews of claim 1, including enabling the users to search for reviews based on an average user ranking of reviews.

7. The method of claim 1, which is provided through a data network.

8. The method of claim 7, wherein the data network is an internet.

9. A non-transitory computer-readable medium including a plurality of executable instructions which, when executed by a processor, cause the processor to:
(a) store data corresponding to a plurality of places on a database;
(b) store data corresponding to a plurality of personality profiles on the database, each one of the personality profiles associated with one of a plurality of users;
(c) enable a reviewer to submit reviews of at least one of the places, each review associated with a personality profile of the reviewer;
(d) store the submitted reviews on the database; and
(e) enable the users to filter reviews based on a degree of correspondence between the personality profile of the user and the personality profile associated with at least one of the reviewers.

10. The non-transitory computer-readable medium of claim 9, wherein when executed by the processor, the plurality of executable instructions cause the processor to provide a benefit to each user who submits a review.

11. The non-transitory computer-readable medium of claim 10, wherein the benefit includes at least one of: a coupon; a monetary reward; a travel discount; and redeemable reward points.

12. The non-transitory computer-readable medium of claim 9, wherein when executed by the processor, the plurality of executable instructions cause the processor to enable the users to rate at least one of any previously submitted reviews.

13. The non-transitory computer-readable medium of claim 9, wherein when executed by the processor, the plurality of executable instructions cause the processor to enable the users to search for reviews based on users who have previously submitted a designated number of reviews.

14. The non-transitory computer-readable medium of claim 9, wherein when executed by the processor, the plurality of executable instructions cause the processor to enable the users to search for reviews based on an average user ranking of reviews.

15. A system comprising:
at least one display device;
at least one input device;
at least one processor; and
at least one memory device which stores a plurality of instructions, which when executed by the at least one processor, cause the at least one processor to operate with the at least one display device and the at least one input device to:
(a) store data corresponding to a plurality of places on a database;
(b) store data corresponding to a plurality of personality profiles on the database, each one of the personality profiles associated with one of a plurality of users;
(c) enable a reviewer to submit reviews of at least one of the places, each review associated with a personality profile of the reviewer;
(d) store the submitted reviews on the database; and
(e) enable the users to filter reviews based on a degree of correspondence between the personality profile of the user and the personality profile associated with at least one of the reviewers.

16. The system of claim 15, wherein when executed by the at least one processor, the plurality of instructions cause the at least one processor to provide a benefit to each user who submits a review.

17. The system of claim 16, wherein the benefit includes at least one of: a coupon; a monetary reward; a travel discount; and redeemable reward points.

18. The system of claim 15, wherein when executed by the at least one processor, the plurality of instructions cause the at least one processor to enable the users to rate at least one of any previously submitted reviews.

19. The system of claim 15, wherein when executed by the at least one processor, the plurality of instructions cause the at least one processor to enable the users to search for reviews based on users who have previously submitted a designated number of reviews.

20. The system of claim 15, wherein when executed by the at least one processor, the plurality of instructions cause the at least one processor to enable the users to search for reviews based on an average user ranking of reviews.
